(19) United States
(12) Patent Application Publication
(10) Pub. No.: US 2018/0135969 A1
(43) Pub. Date: May 17, 2018

(54) SYSTEM FOR MEASURING THE POSITION AND MOVEMENT OF AN OBJECT

(71) Applicant: NIKON METROLOGY N.V., Heverlee (BE)

(72) Inventors: Geert VANDENHOUDT, Kessel-Lo (BE); Patrick BLANCKAERT, Boortmeerbeek (BE); Hans THIELEMANS, Rotselaar (BE)

(73) Assignee: NIKON METROLOGY N.V., Heverlee (BE)

(21) Appl. No.: 15/800,664

(22) Filed: Nov. 1, 2017

Related U.S. Application Data
(63) Continuation of application No. 13/985,907, filed on Oct. 25, 2013, now abandoned.
(60) Provisional application No. 61/444,238, filed on Feb. 18, 2011.

(30) Foreign Application Priority Data
Feb. 18, 2011 (EP) 11155026.5

(51) Int. Cl. G01B 11/14; G01S 17/87; G01S 5/16; G01S 3/784; G01S 3/783; G01S 3/78

(52) U.S. Cl. CPC G01B 11/14; G01S 17/87; G01S 5/163; G01S 5/16; G01S 3/784; G01S 3/783; G01S 3/78; Y10T 29/49769

(57) ABSTRACT

The disclosure relates to a system for measuring the position of an object in a measurement volume, including: an optical angular measurement device, disposed with static optics, configured for measurement of the an azimuth and elevation angle of the object in the measurement volume with respect to the optical angular measurement device, a range measurement device, disposed with static component, configured for measurement of the range of the object in the measurement volume. It further relates to a use of the system and a measurement method.

### FIELD OF THE INVENTION

The invention relates to a system for continuous and accurate measurement of the position of an object in the measurement volume of the system, and its movements (object tracking). If the object is a tactile or optical measurement probe, the system can be used for dimensional verification of industrial and other parts and for reverse engineering of the shape and dimensions of parts.

### BACKGROUND OF THE INVENTION

The optical tracking and measuring system measures 3DOF (3 degrees of freedom, for its position in a XYZ Cartesian reference system) of reflective targets that can be attached to an object. An optical tracking and measuring system is capable of measuring 6DOF (6 degrees of freedom, for example are position and orientation) of an object by measuring the position of at least 3 targets fixed relative to the object.

Optical measuring and tracking systems are known in the art and readily available in industry, such as articulated arms, optical CMM, laser tracker, laser radar, white light projection system. They accurately calculate the position of an object, optionally over a time to track the objects movements.

U.S. Pat. No. 6,166,809 of Pettersen et al. discloses an optical metrology system that uses a combination of a tracker with an optical system for angular measurement. However, the range measurement system is a tracker that employs a motorized deflection mirror. It contains moving components and is thus subject to drift, wear, stability problem, etc. There is a possibility that the motorized detection mirror influences the measurement accuracy. This requires time and expense in monitoring the accuracy of the system and the costs of maintenance.

DE 196 03 267 discloses equipment for the measurement of the range and position of an object. The range measurement employs drives to scan a measurement plane

GB 2 260 051 discloses a tracking system and autofocus system for a camcorder. The tracking and autofocus system employs a motorized drive to track the object being recorded. The system does not return information as to the position or distance of the object being recorded.

The present invention aims to provide an optical measurement and tracking system which avoids accuracy degradation.

### LEGENDS TO THE FIGURES

FIG. 1 depicts an illustration of an optical position measurement system of an embodiment of the invention, together with an object for capture.

FIG. 2 is a schematic illustration of an object for capture that is a non-contact measurement probe.

FIG. 3 is a schematic illustration of an object for capture that is a contact measurement probe.

FIG. 4 is a schematic illustration of a system of an embodiment of the invention configured for metrology using a non-contact measurement probe.

FIG. 5 is a schematic illustration of a system of an embodiment of the invention, in which the range of an object is captured using a range measurement, RM, device.

FIG. 6 is a schematic illustration of a system of an embodiment of the invention, in which the azimuth and elevation angles of an object are captured using an optical angular measurement, OAM, device.

FIG. 7 depicts active and non-active targets utilised by the system, attached to a solid support.

FIG. 8 depicts active and non-active targets utilised by the system, attached to the housing of a tactile probe.

FIG. 9 is a schematic illustration of the combination of data obtained from the range measurement (RM) and optical angular measurement (OAM) device to provide a position of the target in three-dimensional space.

FIG. 10 is a flow chart illustrating the use of the system.

FIG. 11 is a schematic illustration of the working principle of the OAM device.

FIG. 12 is a schematic illustration of a structure manufacturing system.

FIG. 13 is a flow chart illustrating the working principle of the manufacturing system.

### SUMMARY OF THE INVENTION

Measurement systems of the art typically employ a tracker that utilises a motorized deflection mirror. It contains moving components and is thus subject to drift, wear, stability problem, etc. There is a possibility that the motorized detection mirror influences the measurement accuracy. The present invention aims to provide an optical measurement and tracking system which avoids accuracy degradation.

To solve one or more of the above-described problem, the present invention adopts the following constructions as illustrated in the embodiments which correspond to the drawings. However, parenthesized or emboldened reference numerals affixed to respective elements merely exemplify the elements by way of example, with which it is not intended to limit the respective elements.

According to a first aspect of present invention, there is provided a system (100) for measuring the position of an object, comprising:
an angular measurement device (50), disposed with static optics, configured for measurement of the direction of target arranged associated with the object,
a range measurement device (70), disposed with static components, configured for measurement of the range of the object.

According to a second aspect of present invention, there is provided a method for measuring the position of an object, comprising the steps:
placing a target on the object,
measuring a direction of the object using an angular measurement device, disposed with static optics,
measuring the range of the object using a range measurement device, disposed with static components.

According to a third aspect of present invention, there is provided a use of the system or the method of the above-described aspect.

The invention is described according to the following particular embodiments:

One embodiment of the invention is a system (100) for measuring the position of an object (20), comprising:
an optical angular measurement device (50), disposed with static optics, configured for measurement of the direction of the object (20)
a range measurement device (70), disposed with one or more, preferably all static components, configured for measurement of the range of the object (20).

The object is measured in a measurement volume. The direction may be considered the azimuth and elevation angle. The static optics may be configured for measurement of the azimuth and elevation angle of the object in the measurement volume with respect to the optical angular measurement device. The optical angular measurement device (50) may be configured for the measurement of the direction of a first target associated with the object. The range measurement device (70), may be disposed with one or more, preferably all static components, configured for measurement of the range of the object (20) in the measurement volume. The range measurement device (70) may be configured for measurement of the range of a second target associated with the object. The system may further comprise a processing device, configured to calculate the position of the object (20) from the range and the direction. There may be three first targets, and the processing device may be further configured to calculate the orientation of the object. The optical angular measurement device and the range measurement device may be configured for measuring movement of the object, preferably in the measurement volume. A beam of light emitted by the range measurement device may be spatially fixed during the measurement. A beam of the light emitted by the optical angular measurement may be spatially fixed during the measurement. A positional relation between the optical angular measurement device (50) and the range measurement device (70) may be known. The direction preferably includes the azimuth and elevation angle of the target with respect to the optical angular measurement device. The optical angular measurement device may be arranged for measuring a divergence light by using the static optics. The optical angular measurement device (50) may comprise a sensor which detects via the static optics having two one-dimensional optical sensors in non-parallel alignment, or a two dimensional optical sensor. The optical sensors may be of the charged couple device, complementary metal-oxide-semiconductor or position sensitive detector type. The optical angular measurement device (50) may further comprise a fixed-beam light source for illumination of the target by using the static optics. The static component may comprise a time-of-flight measurement system that measures the time delay between emission and detection of wave energy reflected by the object. The time-of-flight measurement system may comprise an emitter for the wave energy that has a fixed beam output. The range measurement device (70) may be an optical range measurement device with optical static component. The emitter may be a laser, or a laser of a coherent laser radar. The emitter may be a sonic or ultrasonic transducer. The object may be a measurement probe or part thereof. The system may further comprise a synchronisation device to synchronise data obtained from the measurement probe with the calculated position and movements of the probe. The first target and the second target may be the same.

Another embodiment of the invention is a method for measuring the position of an object, comprising the steps:
measuring, using an optical angular measurement device, a direction of the object, disposed with static optics; and
measuring, using a range measurement device, disposed with static components, the range of the object.

The method preferably performs the measurement in a measurement volume. The direction of the object may be measured in the measurement volume with respect to the optical angular measurement device. The range of the object may be measured in the measurement volume with respect to the range measurement device. The direction may be measured of a first target arranged associated with the object. The range may be measured of a second target arranged associated with the object.

Another embodiment of the invention is a use of a system (100) described herein, for measurement of the position and movement of an object (20).

Another embodiment of the invention is a method for manufacturing a structure, comprising the steps:
producing the structure using design information;
obtaining shape information of the structure by using of the measurement system described herein; and
comparing the obtained shape information with the design information.

The comparing step determines whether the structure need to be further processed (reprocessed), for example, to correct and production error. The method for manufacturing the structure may further comprise a step of reprocessing the structure based on the comparison result. The reprocessing the structure may include producing the structure over again.

### DETAILED DESCRIPTION OF THE INVENTION

Before the present system and method of the invention are described, it is to be understood that this invention is not limited to particular systems and methods or combinations described, since such systems and methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the following detailed description of the invention, reference is made to the accompanying drawings that form a part hereof, and in which are shown by way of illustration only of specific embodiments in which the invention may be practiced. It is to be understood that other embodiments may be utilised and structural or logical changes may be made without departing from the scope of the present invention. The following detailed description, therefore, is not to be taken in a limiting sense.

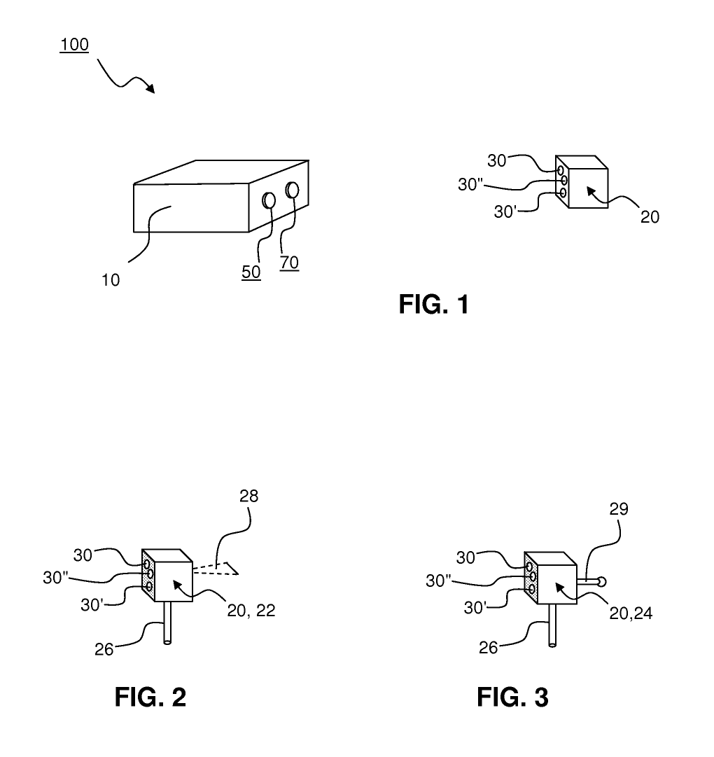

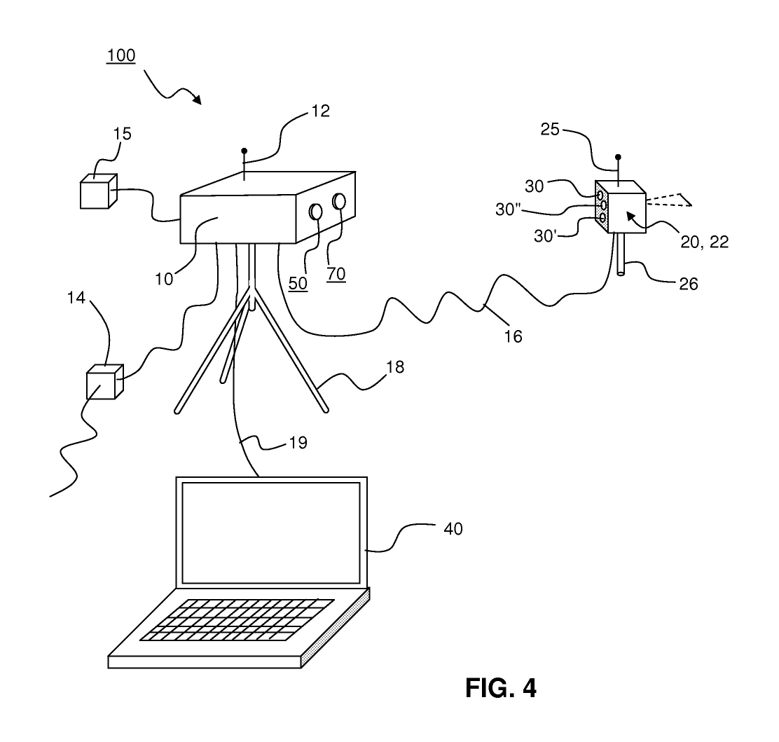

A system according to this embodiment will be described with reference to FIGS. 1 to 4. FIG. 1 depicts an illustration of an optical position measurement system of an embodiment, together with an object for capture. FIG. 2 is a schematic illustration of an object for capture that is a non-contact measurement probe. FIG. 3 is a schematic illustration of an object for capture that is a contact measurement probe. FIG. 4 is a schematic illustration of a system of an embodiment configured for metrology using a non-contact measurement probe.

In FIG. 1, a system 100 includes an optical angular measurement (OAM) device 50 which is disposed with static optics, configured for measurement of the direction of an object, a range measurement (RM) device 70 which disposed with static components, configured for measurement of the range of the object. A target may be arranged associated with the object. Thus system 100 measures the position of the at least one target 30, 30′, 30″ that is located in the measurement volume using a combination of the OAM device 50 and the RM device 70. The targets are placed within the working volume of the OAM and RM devices. By acquiring a plurality of measurements over time, the position of the object 20 can be tracked. While FIG. 1 depicts the object 20 disposed with three targets, it is in no way intended to be limited thereto. When the number of targets is one, the position of the object can be determined. When the number of targets is two, the position and partial orientation of the object can be determined. When the number of targets is three or more, not only the position but also the orientation of the object (i.e. 6DOF) can be determined from the information obtained from the system 100. The use of more than three targets provides redundancy when only the position and orientation are computed which improves accuracy of the measurement or allow for the computation of extra information (e.g. deformation of the object). The object may be a manufactured product, whose position and optionally movements are to be measured. The object may be a measurement probe configured for movement around and measurement of a manufactured product.

The system 100 may include a controller 15. A controller 15 is configured for control of the measuring by a RM device 70 and an OAM device 50. A controller 15 provides control signals for a RM device 70 and an OAM device 50 during a measurement of an object 20 by using a RM device 70 and an OAM device 50.

By utilizing an RM device, the distance of a point from the device can be directly measured, and does not need to be inferred by triangulation as in current optical CMM systems. The accuracy of system is thus improved compared to optical CMMs operating in this manner. In addition, because the direction of the point relative to the measurement device is measured by an optical angular measurement device, the range measurement device does not need to track or follow the point, contrary to laser trackers or laser radars which must employ a steerable mirror to this effect. Because no tracking is necessary, there is no need for moveable heads, no need for costly precision rotary encoders and acquisition can be faster.

The range measurement (RM) device 70 measures the range (i.e. distance) between the object or target and the RM device. The RM device 70 is preferably contactless. It may use a contactless time-of-flight (TOF) measurement system that determines the time delay between transmission and detection of wave energy reflected by the object. The wave energy is preferably light that may be visible or infra-red, but may be any propagating wave energy capable of reflection such as ultrasound or sound. Where the RM device employs light, it is known as an optical range measurement (ORM) device; an optically-detectable target (second target) configured for detection by the ORM device is placed on the object. Where the RM device employs ultrasound or sound, a second target is not necessary.

The RM device 70 preferably comprises an emitter for the propagating wave energy, a detector for receiving the reflected energy, and a RM processor for calculating the ranges based on electrical signals provided to the emitter and received from the detector. The emitter or its output is spatially fixed (non-tracking) for the duration of the measurement. The receiver is also spatially fixed (non-tracking) for the duration of the measurement.

The RM device 70 has static components. The direction of the output of the emitted energy is preferably not electronically controllable. The emitter is preferably non-tracking. The emitter preferably has a fixed beam output. The emitter is preferably wide angle. The emitter output is preferably not focused.

The RM device 70 has a measurement volume within which range measurement of the object can be determined. It overlaps with the measurement volume of the system 100. The measurement volume of the RM device 70 may be held in fixed relation to the RM device. The measurement volume of the RM device 70 may be held in fixed relation to the emitter and/or detector of the RM device 70. The fixed relation may be held during measurement. By fixed relation it is meant fixed position and/or orientation.

The emitter, or beam emitted from the RM device 70 may be fixed during measurement. In other words, the emitter or beam emitted therefrom may be held in a fixed position and orientation during measurement. The emitter or beam emitted from the RM device 70 may be fixed by control signals generated by a controller 15 during measurement. When a beam is emitted by the RM device 70 during measurement, the controller 15 output signals may be fixed for its output of the range measurement.

Where the ORM device 70 is employed, the emitter is a light source having static optics. The direction of the output of the emitted light is preferably not electronically controllable. As such the RM device 70 may be devoid of a steerable mirror. The light emitter is preferably non-tracking. The light emitter is preferably fixed beam. The light emitter is preferably wide angle. The light emitter is preferably not focused. It may be a laser or coherent laser radar. The second target is preferably light reflective 34.

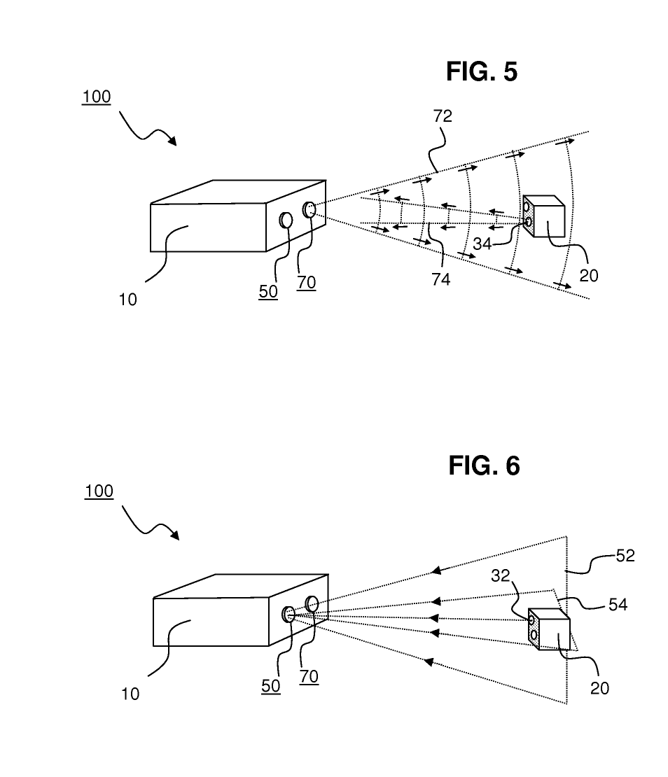

The ORM device 70 works according to known principles of optical range measurement. With reference to FIG. 5, for example, a cone of light 72 is emitted from the ORM device 70 towards the measurement volume. The second target 34 placed on the object 20 that is located within the measurement volume reflects the beam 74 back towards the ORM device 70. Part of the reflected light is picked-up by the receiver in the ORM device 70. Inside the ORM device 70, the receiver combines the received light with the emitted light to determine the time delay between emitted and received beams. The determination of the time delay can be performed for example, with a laser interferometer if the light beam is a laser beam, but any other method known in the art can also be used. From the measured time delay and the known speed of light, the total travel distance of the light from the ORM device to the target and back to the ORM device is calculated by an ORM processor. The outputted range information is directed to the processing device (e.g. a laptop 40), which combined with information received form the OAM device (FIG. 6), calculates the three-dimensional position of the target within the measurement volume. For optimal performance of the optical range measurement, a coherent laser radar beam with a wide beam angle can be used.

Where the ORM device 70 employs ultrasound or sound, the emitter is an ultrasonic or sonic transducer, and the receiver is tuned for detection of the same. The ultrasonic or sonic RM device 70 works according to known principles of ultrasonic or sonic range measurement. In such case, a second target is not necessary. The outputted range information is directed to the processing device (e.g. a laptop 40), which combined with information received form the OAM device (FIG. 6), calculates the three-dimensional position of the target within the measurement volume.

Range measurements are made with respect to the fixed reference system of the RM device. RM devices are known in the art, such as laser radar, laser interferometry, lasertracker, lasertracker with absolute distance measurement. For example, a ray of light of known frequency is sent from the RM device and reflected back by a RM target 30. The reflected signal is combined with the original signal to create an interference from which the phase shift (or the range) between the two signals can be computed.

The optical angular measurement (OAM) device 50 measures the direction of the object. The OAM may preferably measure the direction of an optically-detectable target, in particular the first target, configured for detection by the OAM device placed on the object, relative to the OAM device.

The direction may be represented as the azimuth (or azimuth angle) and elevation (or azimuth angle) of the object or target. Azimuth refers to the angular position of the object or first target relative to a horizontal plane, while the elevation refers to the angular position of the object or first target relative to a vertical plane. It is understood the OAM device allows the azimuth and elevation of an object or target associated therewith to be calculated; this may be derived directly by measuring the azimuth and elevation angles which are perpendicular to each other, or by the determining the angles of the target with respect to any non-parallel projected angles. The azimuth and elevation angles are expressed in a reference system fixed relative to the OAM device 50.

For detection of the object or target 30, the OAM device 50 comprises an optical receiver that is a camera. The receiver may be provided with two one-dimensional optical angle sensors, preferably in orthogonal alignment. In this case, the azimuth and elevation measurements may be carried out separately using each sensor. A one-dimensional optical angle sensor can be a linear optical sensor, combined with an anamorphic lens (e.g. cylindrical optics).

The receiver may be provided with a two-dimensional optical angle sensor. In this case, both azimuth and elevation angles may be measured at the same time. A two-dimensional optical angle sensor may be an area sensor, combined with a spherical lens. The one- or two-dimensional optical sensors may be of the CCD (charged couple device), CMOS (complementary metal-oxide-semiconductor) or PSD (position sensitive detector) type. The angular measurement of the first target using these types of sensors is known in the art.

The OAM device works according to known principles of optical angle measurement. With reference to FIG. 6, for example, a first target that is an active target 32 placed on the object 20 that is located within the measurement volume is detected by a camera in OAM device 50. As the target is an active target 32, no integrated illumination source is necessary in the OAM device 50 or system. The optical angle sensor in the camera determines, from the position of the projection of the target on the sensor, the azimuth 52 of the target 32 and its elevation 54.

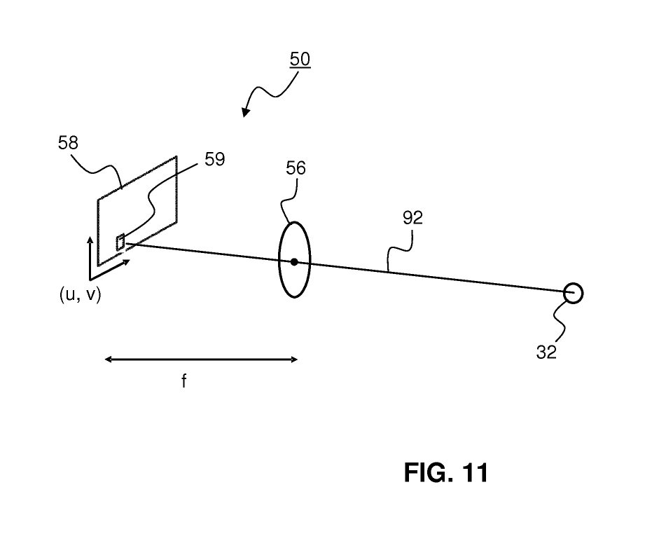

Referring to FIG. 11, a beam of light 92 originating from a first target 32, 34 passes through a lens 56 of the OAM device 50 and strikes the OAM imager 58. The lens and imager are fixed relative to each other and the relative position is usually denoted as the focal distance (f). The imager detects the pixel (u,v) 59 that is lighted by the ray of beam. The direction of the beam (or alternatively the azimuth and the elevation) is thus computed as the vector 92 that passes through the (u,v) pixel and the center of the lens.

The output of the OAM device 50 is directed to the processing device (e.g. a laptop 40, FIG. 4), which combined with information received form the RM device (FIG. 5), calculates the position of the target within the measurement volume. While FIGS. 5 and 6 depict acquisition of range and angle data separately, it will be appreciated that they may be acquired simultaneously or consecutively.

Where the first target is passive 34, the OAM may include an emitter that is a light source for illumination of the same. The light source may be a fixed beam (static, non-tracking) light source. It may be wide angle. Suitable examples of the light source include a flash light (e.g. LED, tungsten or halogen), or a stroboscope. The light source may be incorporated into the housing of the OAM device, or provided separately. For an active 32 first target, a source of illumination integrated in the system is not required.

The OAM device 50 has a measurement volume within which the direction of the object can be determined. It overlaps with the measurement volume of the system 100. The measurement volume of the OAM device 50 may be held in fixed relation to the OAM device 50. The measurement volume of the OAM device 50 may be held in fixed relation to the optical receiver of the OAM device 50. The fixed relation may be held during measurement. By fixed relation it is meant fixed position and/or orientation.

The optical receiver from an OAM device 50 may be fixed during measurement. In other words, the receiver or volume measured by the optical receiver may be held in a fixed position and orientation during measurement. The optical receiver or volume measured by the optical receiver of the OAM device 50 may be fixed by control signals generated by a controller 15 during measurement. When a volume is measured by the OAM device 50 during measurement, the controller 15 output signals may be fixed for its output of the range measurement.

The emitter (light source) of the OAM device 50 or beam emitted therefrom may be fixed during measurement. In other words, the emitter or beam emitted therefrom may be held in a fixed position and orientation during measurement. The emitter or beam emitted therefrom may be fixed by control signals generated by a controller 15 during measurement. When a beam is emitted by OAM device 50 during measurement, the controller 15 output signals may be fixed for its output of the range measurement.

Standard image detection algorithms, known in the art, may be utilised to calculate the position of the reflective target in the image obtained.

An accurate angular measurement may be obtained by common sub-pixelling techniques, or by the use of mathematic algorithms and/or calibration methods. Similar techniques are used in the Nikon Metrology Kseries equipment and in several available optical target measuring and target tracking devices e.g. Metronor SOLO, Creaform Handyscan 3D, GOM tritop.

According to one embodiment of the invention, the OAM device 50 may be an optical coordinate measurement machine (OCMM).

The static components employed by the RM device 70 and the static optics employed by the OAM device 50 refer to the stationary, non-(electro-mechanical) tracking mode of operation. In the case of the RM device 70 employing ultrasound, the ultrasonic emitter and/or receiver are static. In the case of the ORM device 70 the optics are static. The RM device 70 and OAM device 50 components or optics are static at least for the duration of the measurement. The devices 50, 70 may be devoid of a mechanism for an electronically controlled movement of the components, namely the emitter and/or receiver. Where the measurement device 50, 70 provides a light source (e.g. a laser in the case of an ORM device 70), the direction of the output of the transmitted light may not be configured for electronically controllable movement. In other words, it may be devoid of a steerable mirror. Similarly, the receiver component of the measurement device 50, 70 is stationary; the energy received (e.g. light, ultrasound) may not be directed by an electronically controllable mechanism. The use of static components (e.g. optics, ultrasonic transducer) simplifies and reduces the costs of production. The absence of moving parts avoids performance deterioration over time and also increases lifespan. It allows an increased measurement frequency of a moving object since there is no requirement to realign an electromechanical/mechanical tracking system between measurements. Alternatively, it allows the measurement or tracking of several objects “almost” simultaneously.

The static components employed by the RM device 70 and the static optics employed by the OAM device 50 may imply a measurement volume of the system 100 that is fixed relative to the system 100. The measurement volume of the RM device 70 may be fixed relative to the RM device 70, in particular to its emitter and/or receiver. The measurement volume of the OAM device 50 may be fixed relative to the OAM device 50, in particular to its receiver. The intersection between the measurement volumes of the RM device 70 and the OAM device 50 may represent the measurement volume of the system. The measurement volume of the system is the volume within which both direction and range measurements of the object can be determined.

A target 30, 30′, 30″ is an optically detectable device. A target may be a light emitting (active) or reflective (passive) device configured for optical detection by the ORM device or OAM device. The target 30, 30′, 30″ is configured for placement on or attachment to the object. The placement or attachment may be permanent or dismountable. The target 30, 30′, 30″ may be configured for direct placement on the object. The target may be attached to the object using, for instance, a mounting. The mounting may be a magnetic mount, an integrated clamp, a screw-thread assembly, a suction mount, or an adhesive. The target 30, 30′, 30″ may be configured for indirect placement on the object, using for example, a support as elaborated elsewhere herein. The object is susceptible to placement of at least one optically-detectable target 30, 30′, 30″ thereon. The object may be disposed with a suitable surface and/or reciprocating mounting.

There may be two types of target, a first target and a second target. A first target is configured for detection by the OAM device. The first target may be detectable exclusively by the OAM device 50 or non-exclusively i.e. can also be detected by the ORM device 70. A first target may have properties making it suitable for detection only or exclusively by the OAM device 50. The first target may have properties making it suitable for detection by both the OAM device 50 and the ORM device 70.

A second target is configured for detection by the ORM device 70. The second target may be detectable exclusively by the ORM 70 or non-exclusively i.e. can also be detected by the OAM device 50. A second target may have properties making it suitable for detection only or exclusively by the ORM device 70. The second target may have properties making it suitable for detection by both the ORM device 70 and the OAM device 50.

One and the same target may be configured for detection by both of the OAM device 50 and ORM device 70.

When there is a plurality of targets on an object, the distance between them may be known or determined. The number of first targets and second targets may be the same or different.

A first target is configured for detection by the OAM device. Where there is one first target, the azimuth and elevation of the target may be calculated. Where there are at least three first targets, the angular measurements combined with range information may be used to calculate the orientation of the object.

According to one embodiment, the first target is a light-emitting (active) target 32. The active first target 32 may comprise a light transducer for producing light. The light transducer may be, for example, a visible or infra red light-emitting diode (LED), an electroluminescent sheet, or incandescent bulb. It is appreciated that a visible LED may be a single colour, or capable or emitting light of different colours. Light from the light transducer may be directed to the surface of the target using an optical fibre. The light transducer is typically part of electronic circuit comprising a power supply (e.g. battery, solar, inductive, mains transformer), and optionally a controller for providing control signals. The control signals may determinate a static or pulsating output, pulsation rate, light intensity and colour emitted. Where there is a plurality of active first targets, the controller may determine the sequence of illumination. Pulsating light may be optionally for synchronisation (e.g. generation of synchronisation pulses)

According to another embodiment, the first target is a light-reflecting (passive) target 34. The reflected light may be visible, infra red or ultraviolet. The passive first target may be of any suitable type, for instance, a corner cube retro-reflector, retro-reflecting glass bead material, cat-eye retro-reflector, surface with embedded optical pearls, corner cube type imprinted foil.

The passive first target 34 may be illuminated by a fixed beam (static non-tracking) light source; suitable examples thereof include a flash light (e.g. LED, tungsten or halogen), or a stroboscope. The light source may be incorporated into the housing of the OAM device 70, or provided separately.

The passive first target 34 may be illuminated by the fixed beam (static, non-tracking) light source incorporated, alternatively, into the ORM device, which is typically a laser, normally employed to illuminate the second target (see below).

When both the OAM device 50 and the ORM device 70 use passive targets 34, any interference between the range and angle measurements may be avoided in a variety of ways. For example, the illumination sources may be different and use different wavelengths optionally together with appropriate filters in front of the detectors. Alternatively, the OAM and ORM devices may illuminate the target or object asynchronously (at different times), or with a fixed delay.

At least one of the optically-detectable targets (second target) may be configured for detection by the ORM device 70. The second target is light a reflecting (passive) target 34. For optimal performance, it may be a retro-reflector target type that reflects light almost parallel to the incident beam. Examples are of such a target is corner cube (corner reflector), glass sphere, cat-eye, surface with embedded optical pearls, corner cube type imprinted sheet material.

If multiple second targets are used, the ORM device 70 may be able to distinguish between them. Second target measurements may be separated from each other by several techniques. Second targets may be equipped with a shutter function, configured for sequentially visibility to the ORM device 70. The shutter may be in front of the second target or it may be integrated into the body of the second target. The shutter may be mechanical or electro-optical. The shutter is ideally synchronised with the ORM device 70 such that the ORM device can determine which target is active for every range measurement. One aspect is a second target provided with a shutter employing liquid crystal technology (e.g. PI-cell). Another aspect is a second target that is a cat-eye retro-reflector, provided with a shutter located either behind the front lens and in front of the retro-reflector, or in front of the lens. Another aspect is a second target that is a corner cube, provided with a shutter located either behind the front lens and in front of the retro-reflector, or in front of the lens. Another aspect is a second target that is a glass pearl retro-reflector, provided with a shutter located either behind the front lens and in front of the retro-reflector, or in front of the lens. Where the second target contains a shutter, it may be connected to an electronics device for power supply (e.g. battery, solar, inductive, mains transformer) and optionally synchronisation.

A second target may be absent when the RM device employs ultrasound for range detection.

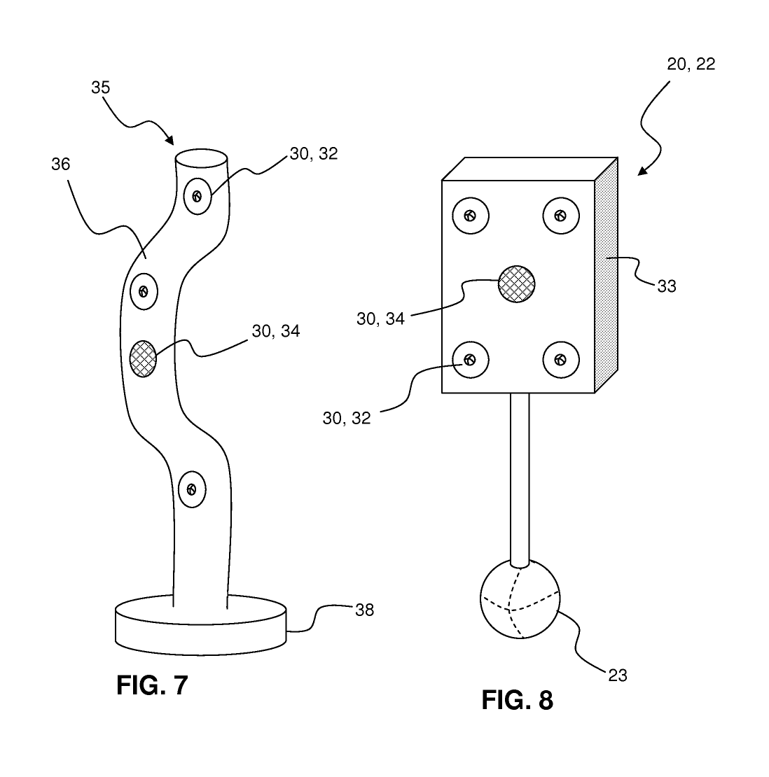

The optically-detectable target 30, 30′, 30″ may be configured for indirect placement on the object. In the case of the latter, it may be attached to a solid support, which in turn is configured for placement on the object, using, for instance, a mounting as described above. FIG. 7 depicts a support for the optically-detectable targets 30, 32, 34 comprising a non-linear shaft 36 to which the optically-detectable targets 30, 32, 34 are in fixed attachment. Preferably, not all the first targets are not aligned in the same plane; in FIG. 7, one first target 32 is set at a different depth. The shaft may be attached to a base 38 using an adjustable or fixed joint. The base 38 may be provided with the mounting. An advantage of a solid support is that the distance between the adjacent targets can be factory calibrated. Other support geometries are envisaged. A support may comprise a regular or irregular polygon in which targets are provided along some or all of the corners and/or edges. For example, a support may comprise a pyramid where 4 targets are located on the corners of the pyramid.

The object 20 may a dimensional measurement probe (see later), in which case the optically-detectable target 30, 30′, 30″ is preferably in fixed attachment to the housing of the probe, preferably at the rear. FIG. 8 depicts a dimensional contact measurement probe 22, where a combination of active 32 and passive 34 targets are attached to the probe housing 33. The probe head 23 is a sphere. Preferably, not all the first targets are aligned in the same plane. The distance between the targets 30, 30′, 30″ may be factory calibrated.

Whether the targets 30, 30′, 30″ are directly or indirectly placed on the object, it will be appreciated that at least some, most or all of the targets are to be placed in the line of sight of the RM and/or OAM devices. The targets 30, 30′, 30″ may be supplied as part of the system or provided separately.

A light-emitting (active) target 32 that pulsates is preferably synchronised on a time scale with the system. Similarly, a passive target 34, equipped with a shutter must also be synchronised. By synchronised, it is meant that it can be determined, for every measurement by the ORM device 70 or OAM device 50, which target is active during the time scale of the measurement. This may be achieved by synchronizing the driving electronics for the targets 32, 34 with the ORM device 70 or OAM device 50 that captures the target. A wired or wireless synchronisation signal sent by the target may allow synchronisation of the electronics. The wireless transmission may be RF (radio frequency) controlled, IR (infra red light) transmission or any other type. Synchronisation may be performed by a synchronisation device; it may be incorporated into the processing device.

According to one aspect of the invention, the object 20 detected by the system is a measurement probe 22, 24 adapted to capture measurement data of another object which might be a large manufactured part for instance. The system 100 may include said measurement probe 22, 24. The measurement probe 22, 24 may be moved across the part to be measured, acquiring data, while the three-dimensional position of the probe 22, 24, and optionally its orientation, can be derived using the system. The measurement probe 22, 24 and the RM device 70 and OAM device 50 are synchronised so that the readings of the probe can be correlated with its position and optionally orientation in space.

Synchronisation methods are known in the art. Synchronisation may be achieved by synchronising the driving electronics for the probe with the RM device 70 or OAM device 50 that captures the probe position. A wired or wireless synchronisation signal sent by the probe allows synchronisation of the electronics. The wireless transmission can be RF (radio frequency) controlled, IR (infra red light) transmission or any other type. Synchronisation may be performed by a synchronisation device; it may be incorporated into the processing device.

The probe may be any kind of probe, for instance, a non-contact probe 22 emitting, for example, a light stripe 28 (FIG. 2) or a contact probe 24 that utilises, for instance, a probe finger 29 (FIG. 3). The probe is configured to capture data; types of data captured by the probe may be any including dimensional, temperature, thickness, colour, luminosity and the like.

Types of non-contact probe 22 (FIGS. 2, 4) include a laser scanner, white light projector, radiation meter, temperature probe, thickness probe, profile measuring probe. The thickness probe may employ ultrasound, or ionising radiation. Types of contact probe 24 include a tactile probe.

The probe 22, 24 may be provided with coupling member 26 configured for attachment to a robot or utilised for hand-held, manual data acquisition.

As mentioned elsewhere, the optically-detectable targets 30, 30′, 30″ are in fixed attachment to the housing 33 of the probe. According to a preferred aspect, there are at least three first targets and at least one second target attached to the probe housing 33. Preferably not all of the first targets are arranged in the same plane as depicted. FIG. 8 depicts a dimensional contact measurement probe 22, where a combination of active 32 and passive 34 targets are attached to the probe housing 33. The probe head 23 is spherical.

Controller

The system 100 may include a controller 15. A controller 15 is configured for control of the measuring by a RM device 70 and an OAM device 50. A controller 15 provides control signals for a RM device 70 and an OAM device 50 during a measurement of an object 20 by using a RM device 70 and an OAM device 50.

Range information from the RM device 70 and direction (azimuth and elevation) data from the OAM device 50 are used to calculate the position of the object 20 in three-dimensional space i.e. its position in a XYZ Cartesian reference system. Where at least three targets 30, 30′, 30″ are employed, additional information is available from the OAM device 50 and/or ORM device 70 to enable also calculation of the orientation of the object or other characteristics of the object such as deformation.

The output of the OAM device 50 and the output of the RM device 70 (FIG. 5), are directed to the processing device which is a main processor, (e.g. a laptop, FIG. 4, 40). The processing device calculates the position of the target within the measurement volume. The same processing device or a separate (first) sub-processor connected to said processing device, may be used to compute the angular information acquired by the OAM device 50 that is used to calculate the position of the target. The same processing device or a separate (second) sub-processor connected to said processing device maybe used to compute the range information acquired by the ORM device 70 that is used to calculate the position of the target. The respective sub-processors may be realized as circuitry comprising a FPGA or DSP, microprocessor or microcontroller located in the RM device 70 and OAM device 50, or in a housing 10 that contains both the RM device 70 and OAM device 50. The processing device may be realized as a computer such as a laptop, desktop having a screen, computer processor and capability to execute a computer program stored on a computer-readable storage medium. Alternatively, it may be realised as circuitry such as a FPGA, DSP, microprocessor or microcontroller, provided inside or outside the RM device 70, or the OAM device 50, or a single housing 10 that contains both the RM device 70 and OAM device 50.

The processing device or main processor may be provided as a single unit, or a plurality of units operatively interconnected but spatially separated. The processing device may be integrated fully or partly into the housing of the RM device 70 or OAM device 50, or into a single housing 10 that contains both the RM device 70 and OAM device 50. Where there is partial integration, it is meant a separate unit outside the housing may contain part of the electronics of the processing device. Alternatively, the processing device be housed fully outside the housing of the OAM device or RM device or the single housing 10 that contains both the RM device 70 and OAM device 50 (e.g. as a laptop, desktop computer, smartphone, tablet device). When the processing device is housed fully outside or is only partly integrated, interconnections between devices utilise a cable or wireless connection (e.g. Bluetooth, Wifi, ZigBee or other standard). It will be appreciated that the sub-processors and/or processing device may also perform other tasks such as synchronisation, system control, power management, I/O communication and the like typically associated with digital systems. The processing device may also operate with other (metrology) devices (both hardware and software).

One or more elements of the system 100, for example the OAM device 50, the RM device 70, the processing device, and the controller 15 may be provided in a plurality of separate housings, or alternatively may be integrated into one single housing 10 (FIG. 1). A single housing offers convenience of portability and size. Additionally, the housing or an internal chassis therein may provide a rigid fixture for the OAM device 50 and the RM device 70, to hold them in a fixed relative spatial alignment for optimal performance.

When the OAM device 50 and the RM device 70 are so rigidly connected, the relation (calibration) between the OAM device and RM device may be readily determined and set for at least part of the lifetime of the system without need for further calibration. The calibration may be set at the factory. The relation may be obtained using a measurement probe that is tracked by the system; when the dimensions of a reference physical object of known size is acquired by the probe, the calibration can be derived by comparing the acquired object dimensions with the dimensions of a nominal (computer generated, not scanned) CAD model of the object. Once the calibration is known, it does not need to be re-calculated for each use; however, it will be appreciated that a calibration may be performed periodically e.g. on a monthly or yearly basis as required.

When the OAM device 50 and the RM device 70 are mounted by the user next to each other, for example, on separate tripods, the relation between the OAM device 50 and the RM device 70 may be evaluated by the user, for example, using the calibration technique described above. A calibration may be performed prior to each separate set up.

It is understood that parts of the optics of the OAM device 50 and ORM device 70 may be shared.

As mentioned elsewhere, the processing device may be integrated into the single housing 10. Other possible housing-integrated components include a power supply (e.g. battery, mains transformer), fan, antenna, communication ports, etc.

As mentioned elsewhere, the position of the target 30, 30′, 30″ within the measurement volume is calculated from the combination of the range measurement value and the azimuth and elevation angle values. The spatial relation between the OAM device 50 and RM device 70 is known or can be calculated. The spatial relation between the targets 30, 30′, 30″ is known or can be calculated.

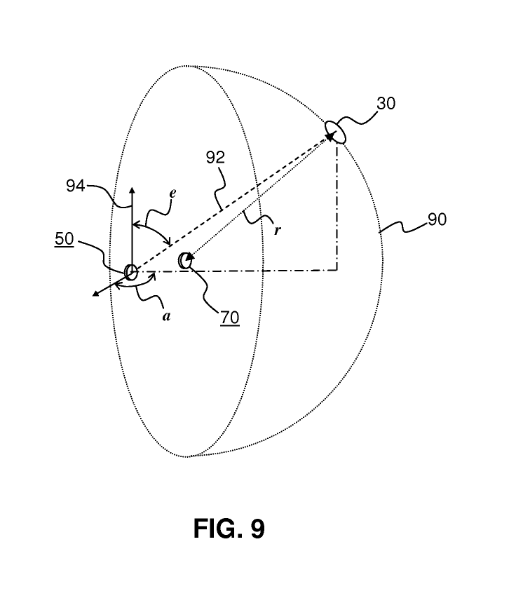

The skilled person will understand how to calculate the position, and subsequently, movement of the object, however, the following is given as general guidance, with reference to FIG. 9. From the range measurement value, it is known that the target 30 is located on a sphere 90 centered at the reference system of the RM device 70 whose radius, r, is the measured range. From the angle values, it is known that the target 30 is located on a ray 92 whose origin is the origin of the reference system 94 of the OAM device 50 and whose direction is given by the azimuth, a, and elevation, e. The position of the target is computed as the intersection between the ray 92 and the sphere 90.

The relative position between the reference system 94 of the OAM device 50 and the and reference system of the RM device 70 can be conventionally described by a 4 by 4 matrix T. Expressed in the reference system of the OAM device 50, the position of the target, P, is given by

P=av, (1)

and

∥T·P∥₂=r. (2)

Replacing P from (1) into (2), gives ∥a T. v∥₂=r, and the equation

a²=r²/∥T·v∥². (3)

gives two solutions for a (and therefore P), one of which is visible by the OAM device 50 and the RM device 70.

The system 100 may be configured for tracking the movement of an object 20. In this application, the position of the target or targets are consecutively measured over a period of time. It is understood that the targets remain within the measurement volume for the duration of the movement. The plurality of measurements are automatically performed. The frequency of measurements (measurements per minute) may be constant, or variable; it may be pre-determined by the user or automatically determined. Measurements are recorded by the system together with timing information. The position of the target as a function of time is thus obtained. Because the optical measuring and tracking system does not contain moving components, it is able to measure successive targets rapidly. Typical sample rates may vary between 0.1 and 10 000 measurements per minute, making it suitable for observing high velocity movements. The sample-frequency may be subsequently up- or down-graded depending on requirements.

In one embodiment of the invention, two or more (e.g. 3, 4, 5, 6, 7, 8, 9, 10 or more) of the aforementioned systems 100 may be interconnected to form an array. Such array may be used to extend the measurement volume, improve accuracy, or performance, for instance. The multiple systems may be synchronised in order to generate synchronised measurement data. Wired or wireless interconnections may be made between multiple optical tracking systems to establish synchronisation.

In the above-described above, the system employs static (non-tracking) optics and components to measure azimuth and elevation, and range of the object. As there is no requirement to aim a laser at the object or target thereon, no moving components such as steerable mirrors are required, leading to less wear and consistent performance over time. The system is useful for position determination, motion measurement and dimensional measurement (when the object is a measurement probe) of large scale objects in at least 3-DOF.

The system uses preferably a time of flight system (e.g. a laser or ultrasonic based system) to measure the range of the object or targets placed thereon. It employs a separate system to measure the azimuth and elevation based on optical target detection. As the OAM device and RM device can be combined in a single system, it is highly portable and robust.

Applications of the system are numerous. It may be used for robot calibration by measurement of the real trajectory and comparison to a nominal trajectory and compensation of measured deviations, measurement of human and animal motion (biomechanical research, motion measurement in wind tunnel experiments). When the object is a measurement probe whose position is tracked, the system can be employed in large scale metrology (100 mm up to 60 m in size or more), dimensional inspection (i.e. actual to nominal comparison regarding geometrical tolerancing) of industrial parts in a fixed measurement setup or as a mobile setup in the production line (automotive, shipbuilding, aerospace, casting, energy, oil, furniture), reverse engineering of dimensions and shape of industrial parts (automotive, shipbuilding, aerospace, furniture), digitizing free shaped objects (art, statues, archaeological sites, characters), automatic assembly of e.g. aircraft components, etc.

Another embodiment of the invention is a method for measuring the position of an object in a measurement volume, comprising the steps:
measuring an azimuth and elevation angle of the object in the measurement volume with respect to the optical angular measurement using an optical angular measurement device, disposed with static optics,
measuring the range of the object using a range measurement device, disposed with static components.

The method may comprise the use of the measurement system 100 described herein.

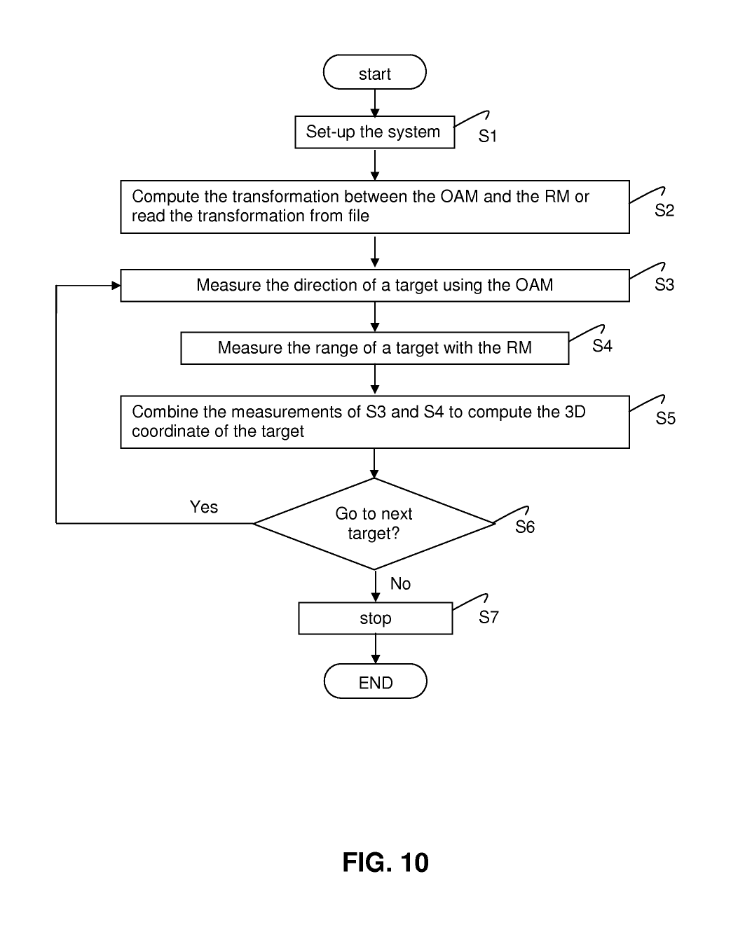

An exemplary operation of the system 100 herein for measuring the position of object is described with reference to the flowchart of FIG. 10.

In a first step S1 (Step 1), the devices of the system are set up, namely, the OAM device 50, ORM device 70 and preferably a separate processing device. In the simplest configuration, the OAM device 50, ORM device 70 will be combined in a single housing 10 which is placed on a support such as a tripod that is directed towards the object on which one or more targets is disposed. A laptop is connected thereto. A system check may be performed, for instance, by measuring an artifact with known dimensional characteristics.

Subsequently S2 (Step 2), the transformation between the OAM device 50 and the ORM device 70 is calculated that is used by the processing device. Alternatively, the transformation is read into the processing device from a file. The system is then ready for measuring the position of the object.

Then S3 (Step 3), the OAM device 50 measures the direction of the target. It is understood that the target is within the measurement volume and oriented so as to be captured by the OAM device 50.

Then S4 (Step 4), the RM device 70 measures the range of a target or of the object. It is noted that Step 4 may be performed before Step 3, or both Step 3 and Step 4 performed at same time. Steps 3 and/or 4 maybe performed more than once to improve the accuracy of the reading. It is noted that the number of RM measurements and OAM measurements need not be the same.

Then S5 (Step 5), the 3D coordinates of the target are computed. The processing device combines the data from the measurement of Steps 3 and 4. This may be achieved by solving equation (3) or similar equations.

The cycle of Step 3, 4 and 5 may be repeated S6 (Step 6), for instance, to determine the position of other targets in the case of multiple targets on the object, and/or to track the movement of the object over time. Once the acquisition is complete the method is stopped S7 (Step 7).

The cycle of Steps 3, 4 and 5 may be repeated for each target of a multi-targeted object i.e. measurement in Steps 3 and 4 for the next target are only acquired after the co-ordinates of the previous target have been calculated in step 5. Alternatively, all the targets may be measured simultaneously in Steps 3 and 4, and processed in Step 5, thereby requiring less iterations; the latter is particularly applicable if the ORM device has a matrix camera and all targets are well separated. It is sufficient to read one frame of the camera and calculate the sets of 3D co-ordinates in parallel, using, for example, with parallel circuitry.

As described above, by measuring the direction of the target by OAM device 50, and the range of the target by RM device 70, it is possible to measure the position of the object. Then, the object can be satisfactorily measured.

Another embodiment of the invention is a system as described herein, for measurement of the position and/or orientation, and optionally the movement of an object.

Another embodiment of the invention is a use of a system as described herein, wherein the object is a manufactured product, whose position and optionally movements are to be measured. Another embodiment of the invention is a use of a system as described herein, wherein the object is a measurement probe (e.g. contact or non-contact) configured for movement around and dimensional measurement of a manufactured product. Another embodiment of the invention is a use of a system as described herein, wherein the system further comprises a synchronisation device to synchronise data obtained from the measurement probe with the calculated position and optionally orientation of the probe.

FIG. 4 shows an exemplary system 100 of the invention comprising the OAM device 50 and RM device 70 together in a single housing 10. The housing 10 is supported on a mobile tripod 18. It will be appreciated that other types of support may be used for example, a fixed tripod, a wall mount support, a ceiling support or any other type of fixed support. The support may be a moveable carriage, a robot, a trolley or any other type of mobile support. A mains transformer 14 provides electrical power to the system. The system further comprises a contactless measurement probe 22 disposed with a plurality of optically detectable targets 30, 30′, 30″ which probe 22 is the object 20 whose position and movements are captured. The system 100 is shown with a controller 15 operatively connected to the RM device 70 and OAM device 50 configured for control of the measuring by the RM device 70 and the OAM device 50.

The system is set up for a metrology application, namely with a dimensional measurement probe 22. The probe 22 contains a coupling 26 which may be attached to the effector end of a robot or utilised as a hand grip for manual data acquisition. The probe 22 is connected to the housed 10 measurement devices 50, 70 by way of a cable 16, which carries the synchronisation signals, probe data, and optionally a power source for the probe. However, for the transfer of data and synchronisation signals, the probe and measurement devices 50, 70 may alternatively or additionally be in wireless communication, facilitated by a wireless antenna 12 on the housing 10 and a wireless antenna 25 on the measurement probe 22. The wireless protocol may be Bluetooth, WiFi, ZigBee, other standard or proprietary protocol. Range information from the RM device and azimuth and elevation data from the OAM device are provided to a processing device, exemplified as a laptop 40, which calculates the position and orientation of the probe 22 in three-dimensional space, and may optionally record the data obtained from the probe 22 preferably in a synchronised mode. Measurements made over time enable the movements of the probe to be determined.

The laptop may communicate with the measurement devices 50, 70 using a cable 19, or using a wireless connection.

The invention also provides for a method for manufacturing a structure, comprising the steps:
producing the structure using design information;
obtaining shape information of structure by using the measurement system 100 described herein; and
comparing the obtained shape information with the design information.

More specifically, the shape information of structure so produced may be obtained using the system 100 described herein in combination with a measurement probe such as a profile measuring probe that is the object. The design information and shape information are preferably stored prior to comparing. The method for manufacturing the structure may further comprise the step of reprocessing the structure based on the comparison result.

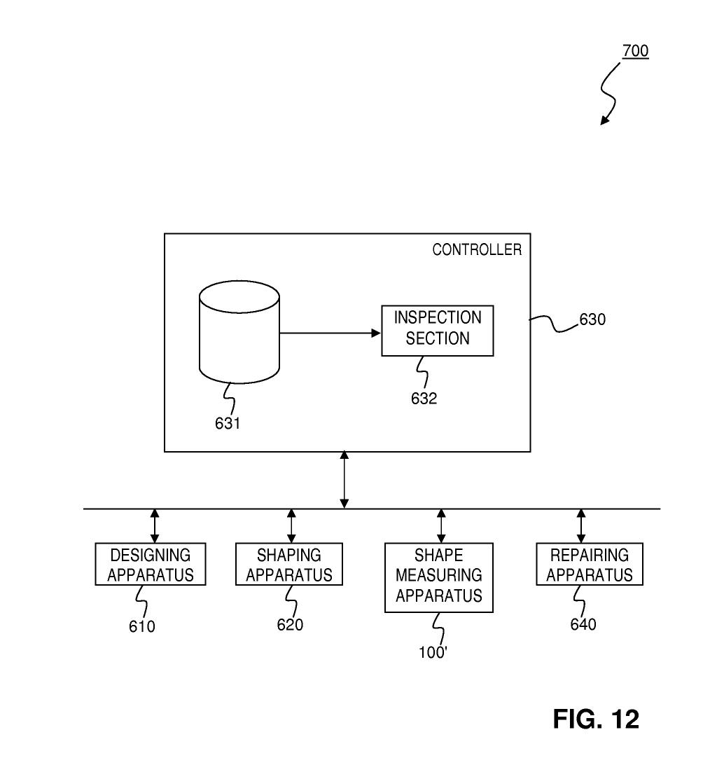

The invention also provides for a structure manufacturing system comprising the system 100 described hereinabove. Depicted in FIG. 12 is a block diagram of a structure manufacturing system 700. The structure manufacturing system 700 is for producing a structure for, for example, a ship, airplane, automotive vehicle and so on, from at least one material, and inspecting the structure so produced using a profile measurement apparatus 100′ which comprises a profile measurement probe in association with the position measurement apparatus 100 described herein. An example of a possible arrangement of a profile measurement apparatus is provided in FIG. 4. The probe may be a profile measuring probe.

The structure manufacturing system 700 of the embodiment includes the profile measuring apparatus 100′, a designing apparatus 610, a shaping apparatus 620, a controller 630 that incorporates an inspection apparatus, and a repairing apparatus 640. The controller 630 includes a coordinate storage section 631 and an inspection section 632.

The designing apparatus 610 creates design information with respect to the shape of a structure and sends the created design information to the shaping apparatus 620. Further, the designing apparatus 610 communicates with the coordinate storage section 631 of the controller 630 to store the created design information therein 631. The design information includes information indicating the coordinates of each position of the structure.

The shaping apparatus 620 produces the structure based on the design information inputted from the designing apparatus 610. The shaping process carried out by the shaping apparatus 620 includes processes such as casting, forging, cutting, machining, 3D printing, and the like. The profile measuring apparatus 100′ measures the coordinates of the produced structure (measuring object) and sends the information indicating the measured coordinates (shape information) to the controller 630.

The coordinate storage section 631 of the controller 630 stores the design information. The inspection section 632 of the controller 630 reads out the design information from the coordinate storage section 631. The inspection section 632 compares the information indicating the coordinates (shape information) received from the profile measuring apparatus 100′ with the design information read out from the coordinate storage section 631. Based on the comparison result, the inspection section 632 determines whether or not the structure is shaped in accordance with the design information. In other words, the inspection section 632 determines whether or not the produced structure is non-defective. When the structure is not shaped in accordance with the design information, then the inspection section 632 determines whether or not the structure is repairable. If repairable, then the inspection section 632 calculates the defective portions and repairing amount based on the comparison result, and sends the information indicating the defective portions and the information indicating the repairing amount to the repairing apparatus 640.

The repairing apparatus 640 performs processing of the defective portions of the structure based on the information indicating the defective portions and the information indicating the repairing amount received from the controller 630.

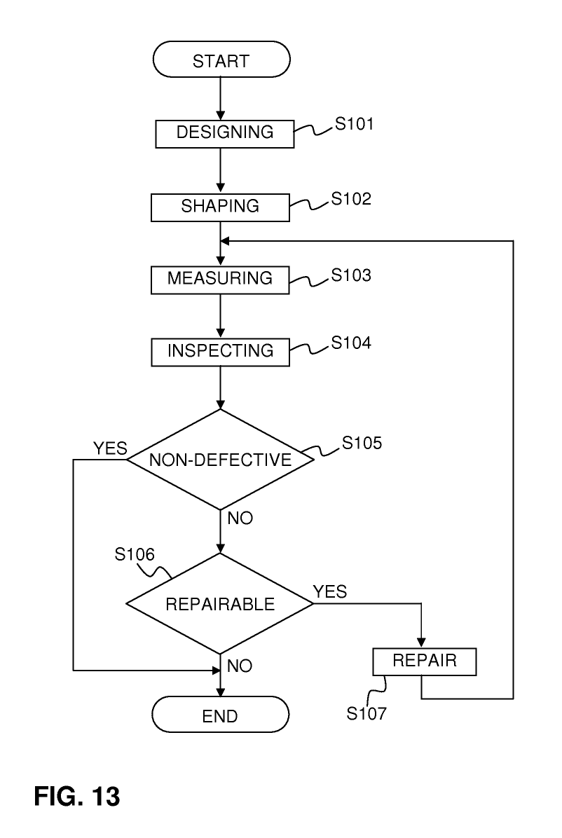

FIG. 13 is a flowchart showing a processing flow of the structure manufacturing system 700. With respect to the structure manufacturing system 700, first, the designing apparatus 610 creates design information with respect to the shape of a structure (step S101). Subsequently, the shaping apparatus 620 produces the structure based on the design information (step S102). Then, the profile measuring apparatus 100′ measures the produced structure to obtain the shape information thereof (step S103). Then, the inspection section 632 of the controller 630 inspects whether or not the structure is produced in accordance with the design information by comparing the shape information obtained from the profile measuring apparatus 100 with the design information (step S104).

Subsequently, the inspection element 632 of the controller 630 determines whether or not the produced structure is nondefective (step S105). When the inspection section 632 has determined the produced structure to be nondefective (“YES” at step S105), then the structure manufacturing system 700 ends the process. On the other hand, when the inspection section 632 has determined the produced structure to be defective (“NO” at step S105), then it determines whether or not the produced structure is repairable (step S106).

When the inspection portion 632 has determined the produced structure to be repairable (“YES” at step S106), then the repair apparatus 640 carries out a reprocessing process on the structure (step S107), and the structure manufacturing system 700 returns the process to step S103. When the inspection portion 632 has determined the produced structure to be unrepairable (“NO” at step S106), then the structure manufacturing system 700 ends the process. With that, the structure manufacturing system 700 finishes the whole process shown by the flowchart of FIG. 13.

With respect to the structure manufacturing system 700 of the embodiment, because the profile measuring apparatus 100′ in the embodiment can correctly measure the coordinates of the structure, it is possible to determine whether or not the produced structure is nondefective. Further, when the structure is defective, the structure manufacturing system 700 can carry out a reprocessing process on the structure to repair the same.

Further, the repairing process carried out by the repairing apparatus 640 in the embodiment may be replaced such as to let the shaping apparatus 620 carry out the shaping process over again. In such a case, when the inspection section 632 of the controller 630 has determined the structure to be repairable, then the shaping apparatus 620 carries out the shaping process (forging, cutting, machining and the like) over again. In particular for example, the shaping apparatus 620 carries out a cutting process on the portions of the structure which should have undergone cutting but have not. By virtue of this, it becomes possible for the structure manufacturing system 700 to produce the structure correctly.

In the above embodiment, the structure manufacturing system 700 includes one or more of, preferably all of the profile measuring apparatus 100′, the designing apparatus 610, the shaping apparatus 620, the controller 630 (inspection apparatus), and the repairing apparatus 640. However, present teaching is not limited to this configuration. For example, a structure manufacturing system in accordance with the present teaching may include at least the shaping apparatus 620 and the profile measuring apparatus 100.

1. A system for tracking in a measurement volume a position of a moving object or of at least one target on an object in the measurement volume, comprising:
an optical angular measurement device, disposed with static optics, configured for measurement of azimuth and elevation angles of an object in the measurement volume with respect to the optical angular measurement device;
a range measurement device, disposed with a static component, configured for measurement of a range of the object in the measurement volume; and
a processing device, configured to calculate a position of the object from the range and the azimuth and elevation angles of the object;
wherein said measurement volume is an intersection of a measurement volume of the optical angular measurement device and of a measurement volume of the range measurement device; and
wherein the measurement volumes of the optical angular measurement device and of the range measurement device are rotationally fixed relative to each other for a duration of the tracking measurement.

2. The system according to claim 1, wherein the optical angular measurement device is configured for measurement of the azimuth and elevation angle of a first target associated with the object, and the range measurement device is configured for measurement of the range of a second target associated with the object.

3. The system according to claim 2, wherein the first target includes three targets, and the processing device is configured to calculate an orientation of the object.

4. (canceled)

5. The system according to claim 1, wherein a beam of light emitted by the range measurement device is spatially fixed during the range measurement.

6. The system according to claim 1, wherein a beam of the light emitted by the optical angular measurement device is spatially fixed during the azimuth and elevation measurement.

7. The system according to claim 1, wherein a positional relation between the optical angular measurement device and the range measurement device is known.

8. The system according to claim 1, wherein the optical angular measurement device is arranged for measuring a divergence light by using the static optics.

9. The system according to claim 1, wherein the optical angular measurement device comprises:
a sensor for detecting via the static optics having
two one-dimensional optical sensors in non-parallel alignment, or
a two dimensional optical sensor.

10. The system according to claim 9, wherein each optical sensor is of the charged couple device, complementary metal-oxide-semiconductor or position sensitive detector type.

11. The system according to claim 2, wherein the optical angular measurement device comprises:
a fixed-beam light source for illumination of the first target by using the static optics.

12. The system according to claim 1, wherein the static component comprises:
a time-of-flight measurement system configured for measuring a time delay between emission and detection of a wave energy reflected by the object.

13. The system according to claim 12, wherein the time-of-flight measurement system comprises:
an emitter for the wave energy that has a fixed beam output.

14. The system according to claim 12, wherein the range measurement device is an optical range measurement device with the static component.

15. The system according to claim 13, wherein the emitter is a laser, or a laser of a coherent laser radar.

16. The system according to claim 13, wherein the emitter is a sonic or ultrasonic transducer.

17. The system according to claim 1, wherein the object is a measurement probe.

18. The system according to claim 17, comprising:
a synchronisation device for synchronising measurement data obtained from the measurement probe with a calculated position and movements of the probe.

19. The system according to claim 2, wherein the first target and the second target are a same target.

20. A method for measuring a position of an object within a measurement volume, comprising:
measuring, using an optical angular measurement device disposed with static optics, azimuth and elevation angles of the object in the measurement volume with respect to the optical angular measurement device;
measuring, using a range measurement device disposed with static components, a range of the object; and
calculating, by a processing device, the position of the object from the range and the azimuth and elevation angles of the object,
wherein said measurement volume is an intersection of a measurement volume of the optical angular measurement device and of a measurement volume of the range measurement device, and
wherein the measurement volumes of the optical angular measurement device and of the range measurement device are fixed relative to each other.

21. The system according to claim 1, in combination with an object, for measurement of the position and movement of the object.

22. (canceled)

23. (canceled)

24. (canceled)

25. The system according to claim 1, wherein at least one of the range measurement device and the optical angular measurement device is devoid of a mechanism for electronically controlled movement of a component therein to track movement of the object or of the least one target on the object.

26. The system according to claim 1, wherein at least one of the range measurement device and the optical angular measurement device is devoid of a steerable mirror.
